(19) United States
(12) Patent Application Publication
(10) Pub. No.: US 2026/0341717 A1
(43) Pub. Date: Oct. 29, 2026

(54) BINDER COMPOSITION FOR SECONDARY BATTERY

(71) Applicant: Arkema Inc., King of Prussia, PA (US)

(72) Inventors: Jinbao CAO, King of Prussia, PA (US); Wenjun WU, King of Prussia, PA (US); Lei YANG, King of Prussia, PA (US); Willis LECORCHICK, King of Prussia, PA (US)

(21) Appl. No.: 18/880,916

(22) PCT Filed: Jun. 28, 2023
(86) PCT No.: PCT/US2023/026396

§ 371 Date: Jan. 3, 2025

Related U.S. Application Data
(60) Provisional application No. 63/358,580, filed on Jul. 6, 2022.

(51) Int. Cl. H01M 4/62; H01M 4/04

(52) U.S. Cl. CPC H01M 4/622; H01M 4/0404

(57) ABSTRACT

An aqueous emulsion composition useful as a binder for a non-aqueous battery electrode is provided. The composition includes a copolymer and an anionic surfactant that includes a sulfonate group or acid or salt form thereof. The anionic surfactant is not polymerizable with the copolymer. The copolymer includes as polymerized monomers: an ethylenically unsaturated ionic monomer including a phosphate or phosphonate group or salt or acid forms thereof; an ethylenically unsaturated ionic monomer including a sulfonate group or salt or acid forms thereof; a non-ionic monoethylenically unsaturated monomer; optionally an ethylenically unsaturated ionic monomer including a carboxylate group or salt or acid or anhydride form thereof; and optionally a monomer having at least two ethylenic unsaturations. A slurry composition including the aqueous emulsion composition and an active material is also provided.

### FIELD OF THE INVENTION

The invention relates to binder compositions for electrodes of a non-aqueous secondary battery. Secondary batteries are rechargeable batteries.

### BACKGROUND OF THE INVENTION

There has been increasing interest in light weight and high energy density secondary battery technology. Lithium-ion batteries (LIB) have been used widely as the power source for many devices, such as consumer electronics, electric vehicles, and power tools. The growing popularity of zero-emission electric vehicles, particularly long-range electric vehicles, demands LIB technology with further improved energy density, and durability. To improve battery energy density and durability, different components of a battery are being investigated. These components include the negative electrode (anode), the positive electrode, the electrolyte and the separator. Improved electrode capacity has great potential to boost battery energy density, in particular, if improved binders are used.

The ongoing industrial trend to improve the battery energy density and the advancement of electrode active material presents new challenges for traditional polymeric binders. Stable battery cycling at elevated temperature is especially challenging. The swelling of binder in battery solvent mixture is an important factor affecting battery's cycling stability and ideally should be controlled within a certain range.

U.S. Pat. No. 10,957,909 discloses a binder composition comprising phosphoric acid functional group for non-aqueous battery application.

U.S. Pat. No. 9,499,691 discloses an emulsion polymer composition comprising a phosphorus acid monomer and a carboxylic acid/sulfur acid monomer and internal crosslinker.

U.S. Pat. No. 8,318,848 discloses an emulsion polymer composition comprising a phosphorus acid monomer and an unsaturated acidic monomer and a non-ionic surfactant.

US 2016/0248095 discloses a binder composition comprising unsaturated carboxylic acid, internal crosslinker and acetylene glycol compounds for non-aqueous battery application.

US 2015/0361291 discloses a multi-stage emulsion polymer composition comprising a phosphorus acid monomer, a carboxylic acid/sulfur acid monomer and internal crosslinker.

US 2008/0269402 discloses an emulsion polymer composition comprising a phosphorus acid monomer, a sulfur acid monomer and internal crosslinker.

JP 2013-168323 discloses a binder composition comprising at least one monomer with alkoxysilyl group and at least one acidic group-containing monomer for a non-aqueous battery.

JP 2011-243464 discloses a binder composition comprising unsaturated carboxylic acid and internal crosslinking agent as essential components for a non-aqueous battery.

JP H-10298386 discloses a binder composition comprising sulfonated polyvinylidene fluoride for a non-aqueous battery.

A need remains for a binder composition to be used on the electrodes of a secondary non-aqueous battery that provides a secondary battery having high energy density and excellent service life over a wide service temperature range. A need also exists for a binder composition having enhanced resistance to swelling upon exposure to the battery solvent in order to provide a secondary battery with good cycling stability and high energy density.

### SUMMARY

In the present invention, the inventors developed a binder composition with excellent battery solvent swelling resistance. The binder compositions of the invention swell in battery solvent in a desirable amount and/or optimized fashion.

An aqueous emulsion composition for a non-aqueous battery electrode is provided. The composition comprises: a) a copolymer in the form of emulsified particles; and b) about 0.5-5 wt % by dry weight of the copolymer a) of at least one anionic surfactant. The anionic surfactant b) comprises at least one sulfonate group or acid or salt form thereof. The anionic surfactant b) is not polymerizable with copolymer a).

The copolymer a) comprises, as polymerized monomers, based on the dry weight of the copolymer:
i) about 0.1-10 wt % of at least one ethylenically unsaturated ionic monomer comprising at least one functional group selected from phosphate, phosphonate; or acid or salt forms thereof;
ii) about 0.1-10 wt % of at least one ethylenically unsaturated ionic monomer comprising at least one sulfonate group or acid or salt forms thereof;
iii) about 80-99.8 wt % of at least one non-ionic monoethylenically unsaturated monomer;
iv) optionally about 0-10 wt % of at least one ethylenically unsaturated ionic monomer comprising at least one functional group selected from carboxylate, or acid or salt or anhydride forms thereof; and
v) optionally about 0-2 wt % of at least one monomer comprising at least two ethylenic unsaturations.

A slurry composition for forming an electrode for a non-aqueous secondary battery is also provided. The slurry composition comprises the aqueous emulsion composition and at least one particulate electrode-forming material.

An electrode for a non-aqueous secondary battery is also provided. The electrode comprises an electroconductive substrate coated on at least one surface with the slurry composition.

### DETAILED DESCRIPTION

As used herein, the term “electrode” refers to the dried layer or coating of the electrode-forming slurry composition that is cast onto the current collector. Typically, electrodes are manufactured by casting the slurry or paste of dispersed electrode-forming ingredients and binder(s) as a thin layer or coating or film and then allowing the layer or coating or film to dry to form an electrode. This is referred to as the electrode.

As used herein, the term “electrode assembly” refers to or comprises the combination of the current collector and the electrode that is formed thereon. The slurry or paste of dispersed electrode-forming ingredients and binder(s) can be cast onto a current collector such as an aluminum, copper or nickel foil to form the electrode assembly. The electrode assembly can be further coated with a separator-forming slurry such as alumina and binder dispersed in water. The separator slurry can be cast simultaneously with the electrode slurry in a one-step process using a dual or a multi-die in a wet-on-wet process. Alternatively, after the electrode is formed, the separator slurry may be cast onto the electrode, or a free standing separator can be adhered onto the electrode surface. The electrode assembly therefore includes the current collector, the dried electrode film, and optionally a separator film on the top surface of the electrode.

As used herein, the term “slurry” refers to a free-flowing pumpable suspension comprising fine solid materials and binder in water. Such fine solids may include, inter alia, polymeric binder particles, in addition to the solid particles that are usually the electrochemically active material(s) and conductive materials(s) necessary to form the electrode for a secondary battery. Various additives may also be dissolved in the water such as dispersing agents used to improve the quality dispersion, of the fine solid material.

The composition for use as an electrode can be deposited by any method known in the art. Non-limiting examples of such application methods include spraying, rolling, draw bar application, bird bar application, gravure, slot coating, or other coil coating methods. The composition is dried optionally with heat. The coating of the composition may be optionally calendered before or after the drying step, to remove water and any other volatile materials. The drying times, temperatures, and any vacuum used can be adjusted to achieve the desired drying.

The current collector may be in the structural form of a mesh, a foam, a foil, a rod, or another morphology that does not interfere with current collector function. Current collector materials vary depending on whether an electrode is a positive electrode or a negative electrode. The most common current collectors for a negative electrode are sheets or foils of aluminum (Al°), copper (Cu°) or nickel (Ni°) metal. The electrode material is applied to and adheres to the surface of the current collector of the lithium ion battery.

Described herein is an aqueous emulsion composition for a non-aqueous battery electrode, the composition comprising a) a polymeric binder in the form of an aqueous emulsion of polymeric particles and b) an anionic surfactant that comprises at least one sulfonate group or acid or salt form thereof. The anionic surfactant b) is not polymerizable with the copolymer a). The emulsion composition, when sufficiently or substantially or totally dried, provides a matrix for the particulate electrode-forming materials, which typically include an active material and a conductive material. Importantly, the aqueous emulsion binder composition comprising the polymeric particles a) and the anionic surfactant b) is resistant to swelling when in contact with the typical solvents used in non-aqueous electrolyte of the secondary battery. Non-limiting examples of non-aqueous electrolytes are alkyl carbonates, linear dialkyl carbonates, ethers, or mixtures thereof. Non-limiting examples of specific such solvents include propylene carbonate, ethylene carbonate, diethyl carbonate, dimethyl carbonate or mixtures thereof.

### Copolymer a)

As discussed in more detail below, the copolymer a) comprises, consists of, or consists essentially of, as polymerized monomers, a number of monomers. The selection of polymerization method for the disclosed copolymer a) is not particularly limited. Any polymerization method can be used to synthesize the disclosed copolymer a). Non-limiting examples of polymerization methods may include solution polymerization, emulsion polymerization, bulk polymerization, suspension polymerization, free radical polymerization, controlled polymerization, or ionic polymerization. In one preferred embodiment, the copolymer a) is prepared through free radical polymerization via emulsion polymerization.

The copolymer a) may have a volume average particle size of from 30-500 nm, or can be a mix of various particle sizes from 30-500 nm. The volume average particle size is preferably within the range of 30-400 nm, and more preferably within the range of 40-350 nm, and even more preferably within the range of 50-300 nm. For example, the volume average particle size of the emulsified copolymer a) may be at least 30, 40, 50, 60, 70, 80, 90, 100, 110, 120, 130, 140, 150, 160, 170, 180, 190, 200, 210, 220, 230, 240, 250, 260, 270, 280, 290 or at least 300 nm. The volume average particle size of the emulsified copolymer a) may be at most 500, 490, 480, 470, 460, 450, 440, 430, 420, 410, 400, 390, 380, 370, 360, 350, 340, 330, 320, 310 or at most 300 nm. As used herein, volume average particle sizes are determined by dynamic light scattering (DLS) using a Nanotrac UPA150 from Microtrac.

The copolymer a) may have a Tg of less than 55° C., preferably less than 45° C., more preferably less than 35° C., most preferably less than 25° C. Thermal analysis using Differential Scanning calorimetry (DSC) can provide a convenient method to measure the glass transition temperature (Tg) of the copolymer a) after drying. The measurements are performed in accordance with ATSM-D3418-15 (2018) using a standard heating rate of 10° C./min. The reported measured glass transition temperatures in this disclosure are measured during the second heating cycle unless noted otherwise. Glass transition temperatures reported herein are calculated using the Fox equation:

$$1 / Tg == {\sum }_{1}^{i} {w}_{i} / {Tg}_{i}$$

wherein, Tg is the glass transition temperature of copolymer, wᵢ is the weight fraction of monomer i in copolymer, Tgᵢ is the glass transition temperature of homopolymer of monomer i.

The copolymer a) may have a minimum film forming temperature (MFFT) of less than 25° C., preferably less than 20° C., more preferably less than 15° C. The MFFT may be determined in accordance with ASTM-D2354-10 (2018) entitled “Standard Test Method for Minimum Film Formation Temperature (MFFT) of Emulsion Vehicles” to ensure the fluidity and malleability of the resin particles and thereby their ability to coalesce.

The copolymer a) may have a number average molecular weight (Mn) of at least 1,000 g/mol, preferably at least 5,000 g/mol, more preferably at least 10,000 g/mol. Unless stated otherwise, the number average molecular weight is measured with gel permeation chromatography using polymethylmethacrylate (PMMA) standards. If the copolymer a) is cross-linked, the sample is extracted with tetrahydrofuran (THF) and the extractables are then dried. The molecular weight measurement is then carried out on the dried extractable fraction of the sample and reported as the Mn.

The copolymer a) comprises, as polymerized monomers, the following monomers. The amounts are recited in weight percent, based on the dry weight of the copolymer a).
i) about 0.1-10 wt % of at least one ethylenically unsaturated ionic monomer comprising at least one functional group selected from phosphate, phosphonate; or acid or salt forms thereof;
ii) about 0.1-10 wt % of at least one ethylenically unsaturated ionic monomer comprising at least one sulfonate group or acid or salt forms thereof;
iii) about 80-99.8 wt % of at least one non-ionic monoethylenically unsaturated monomer;
iv) optionally about 0-10 wt % of at least one ethylenically unsaturated ionic monomer comprising at least one functional group selected from carboxylate, or acid or salt or anhydride forms thereof; and
v) optionally about 0-2 wt % of at least one monomer comprising at least two ethylenic unsaturations.

### i) Ethylenically Unsaturated Ionic Monomer

The copolymer a) comprises as a polymerized monomer, about 0.1-10 wt. % of at least one ethylenically unsaturated ionic monomer i) comprising at least one functional group selected from phosphate, phosphonate; or acid or salt forms thereof. The ionic monomer i) may comprise at least one of phosphate esters of polyalkylene glycol mono(meth)acrylate, polyalkylene glycol allyl ether phosphates, vinylphosphonic acid, 2-(methacryloyloxy)ethyl phosphonic acid; or acid or salt or anhydride forms thereof; or mixtures thereof.

The copolymer a) may comprise at least about 0.1, 0.2, 0.3, 0.4, 0.5, 0.6, 0.7, 0.8, 0.9, 1.0, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, 5.0, 5.2, 5.4, 5.6, 5.8, 6.0, 6.2, 6.4, 6.6, 6.8, 7.0, 7.2, 7.4, 7.6, 7.8, 8.0, 8.2, 8.4, 8.6, 8.8, or at least about 9.0 wt. % of the ethylenically unsaturated ionic monomer i) based on the total dry weight of the copolymer a). The copolymer a) may comprise at most about 10.0, 9.9, 9.8, 9.7, 9.6, 9.5, 9.4, 9.3, 9.2, 9.1, 9.8, 8.8, 8.6, 8.4, 8.2, 8.0, 7.8, 7.6, 7.4, 7.2, 7.0, 6.8, 6.6, 6.4, 6.2, 6.0, 5.8, 5.6, 5.4, 5.2, 5.0, 4.8, 4.6, 4.4, 4.2, 4.0, 3.8, 3.6, 3.4, 3.2, 3.0, 2.8, 2.6, 2.4, 2.2, 2.0, 1.8, 1.6, 1.4, 1.2, or at most about 1.0 wt. % of the ethylenically unsaturated ionic monomer i) based on the total dry weight of the copolymer a).

### ii) Ethylenically Unsaturated Ionic Monomer

The copolymer a) also comprises about 0.1-10 wt % of at least one ethylenically unsaturated ionic monomer comprising at least one sulfonate group or acid or salt forms thereof. The ethylenically unsaturated ionic monomer ii) may comprise at least one of 2-acrylamide-2-methylpropane sulfonic acid, 4-styrenesulfonic acid, vinylsulfonic acid, 2 sulfoethyl methacrylate, sulfoethyl acrylate, sulfopropyl methacrylate, sulfopropyl acrylate; in acid forms, and/or salt forms; and mixtures thereof.

According to an embodiment, the ionic monomers i) and ii) may comprise a single ionic monomer which includes both the at least one functional group selected from phosphate, phosphonate; or acid or salt forms thereof; and the at least one sulfonate group or acid or salt forms thereof. If present, the copolymer a) comprises from 0.2-20 wt % of the single ionic monomer.

The copolymer a) may comprise at least about 0.2, 0.3, 0.4, 0.5, 0.6, 0.7, 0.8, 0.9, 1.0, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, 5.0, 5.2, 5.4, 5.6, 5.8, 6.0, 6.2, 6.4, 6.6, 6.8, 7.0, 7.2, 7.4, 7.6, 7.8, 8.0, 8.2, 8.4, 8.6, 8.8, 9.0, 9.2, 9.4, 9.6, 9.8, 10.0, 10.2, 10.4, 10.6, 10.8, 11.0, 11.2, 11.4, 11.6, 11.8, 12.0, 12.2, 12.4, 12.6, 12.8, 13.0, 13.2, 13.4, 13.6, 13.8, 14.0, 14.2, 14.4, 14.6, 14.8, 15.0, 15.2, 15.4, 15.6, 15.8, 16.0, 16.2, 16.4, 16.6, 16.8, 17.0, 17.2, 17.4, 17.6, 17.8, 18.0, 18.2, 18.4, 18.6, 18.8, or at least about 19.0 wt. % of the single ionic monomer which includes both the at least one functional group selected from phosphate, phosphonate; or acid or salt forms thereof; and the at least one sulfonate group or acid or salt forms thereof, based on the total dry weight of the copolymer a). The copolymer a) may comprise at most about 20.0, 19.9, 19.8, 19.7, 19.6, 19.5, 19.4, 19.3, 19.2, 19.1, 19.0, 18.8, 18.6, 18.4, 18.2, 18.0, 17.8, 17.6, 17.4, 17.2, 17.0, 16.8, 16.6, 16.4, 16.2, 16.0, 15.8, 15.6, 15.4, 15.2, 15.0, 14.8, 14.6, 14.4, 14.2, 14.0, 13.8, 13.6, 13.4, 13.2, 13.0, 12.8, 12.6, 12.4, 12.2, 12.0, 11.8, 11.6, 11.4, 11.2, 11.0, 10.8, 10.6, 10.4, 10.2, 10.0, 9.9, 9.8, 9.7, 9.6, 9.5, 9.4, 9.3, 9.2, 9.1, 9.0, 8.8, 8.6, 8.4, 8.2, 8.0, 7.8, 7.6, 7.4, 7.2, 7.0, 6.8, 6.6, 6.4, 6.2, 6.0, 5.8, 5.6, 5.4, 5.2, 5.0, 4.8, 4.6, 4.4, 4.2, 4.0, 3.8, 3.6, 3.4, 3.2, 3.0, 2.8, 2.6, 2.4, 2.2, 2.0, 1.8, 1.6, 1.4, 1.2, or at most about 1.0 wt. % of the single ionic monomer which includes both the at least one functional group selected from phosphate, phosphonate; or acid or salt forms thereof; and the at least one sulfonate group or acid or salt forms thereof, based on the total dry weight of the copolymer a).

iii) Non-Ionic Monoethylenically Unsaturated Monomer

The copolymer a) comprises about 80-99.8 wt % of at least one non-ionic monoethylenically unsaturated monomer iii). Non-limiting examples of suitable monomers iii) are non-water soluble lower alkyl esters of (meth)acrylic or other acids) and/or an associative monomer containing hydrophobic groups, such as hydrophobically modified polyoxyalkylene ester(s) and monomers containing non-ionic groups. Suitable non-ionic ethylenically unsaturated monomers iii) include but are not limited to acrylic and methacrylic acid esters, such as C1 to C12 (meth)acrylates, (meth)acrylamides, (meth)acrylonitriles, vinyl acetate, styrene and derivatives thereof, diisobutylene, vinylpyrrolidone, vinylcaprolactam, and mixtures thereof.

According to an embodiment, the non-ionic monoethylenically unsaturated monomer iii) comprises at least one of C1 to C12 alkyl (meth)acrylate, styrene or derivatives thereof, vinyl acetate, vinyl versatate, (meth)acrylamide, (meth)acrylonitrile or derivatives thereof, diisobutylene, vinylpyrrolidone, vinylcaprolactam; or mixtures thereof. The non-ionic monoethylenically unsaturated monomer iii) is preferably styrene, methyl (meth)acrylate, ethyl meth (acrylate), propyl meth (acrylate), butyl (meth)acrylate, 2-ethylhexyl (meth)acrylate, octyl (meth) acrylate, decyl (meth)acrylate and lauryl (meth)acrylate and more preferably styrene, butyl (meth) acrylate, 2-ethylhexyl (meth)acrylate, octyl (meth)acrylate, decyl (meth)acrylate and lauryl (meth)acrylate.

According to some embodiment, the copolymer a) comprises, as a polymerized monomer, from 80-99.8 wt % of the at least one non-ionic monoethylenically unsaturated monomer iii), preferably from 90-99.8 wt % and more preferably from 95-99 wt % of the at least one non-ionic monoethylenically unsaturated monomer iii).

According to certain embodiments, the copolymer a) comprises, as a polymerized monomer, at least 80, 81, 82, 83, 84, 85, 86, 87, 88, 89, 90, 91, 92, 93, 94, 95, 96, 97, or at least 98 wt % of the at least one non-ionic monoethylenically unsaturated monomer iii). According to some embodiments, the copolymer a) comprises, as a polymerized monomer, at most 99.8, 99, 98, 97, 96, 95, 94, 93, 92, 91, 90, or at most 89 wt. % of the at least one non-ionic monoethylenically unsaturated monomer iii).

### iv) Ethylenically Unsaturated Ionic Monomer

According to an embodiment, the copolymer a) may optionally comprise, as polymerized monomer, a monomer iv) comprising at least one functional group comprising carboxylate, or acid or salt or anhydride forms thereof. The monomer iv) may comprise at least one of (meth) acrylic acid, 2-carboxyethyl acrylate, 2-polycarboxy ethyl acrylate, mono-ester of itaconic acid, maleic acid, fumaric acid, crotonic acid, itaconic acid; or acid or salt or anhydride forms thereof; or mixtures thereof. Preferably, the monomer iv) is (meth)acrylic acid, itaconic acid, 2-carboxyethyl acrylate, or maleic acid, fumaric acid and more preferably is (meth)acrylic acid, itaconic acid, or 2-carboxyethyl acrylate.

If present, the copolymer a) comprises, as a polymerized monomer, about 0-10 wt. % of the at least one monomer iv) comprising carboxylate, or acid or salt or anhydride forms thereof, based on the dry weight of the copolymer a). According to some embodiments, the copolymer a) comprises at least about 0.05, 0.1, 0.5, 1.0, 1.5, 2.0, 2.5, 3.0, 3.5, 4.0, 4.5, 5.0, 5.5, 6.0, 6.5, 7.0, 7.5, or at least about 8.0 wt. % of the monomer iv) by dry weight of the copolymer a). According to some embodiments, the copolymer a) includes at most about 10.0, 9.5, 9.0, 8.5, 8.0, 7.5, 7.0, 6.5, 6.0, 5.5, 5.0, 4.5, 4.0, 3.5, 3.0, 2.5, 2.0, 1.5, or at most about 1.0 wt. % of the monomer iv) as a polymerized monomer, by dry weight of the copolymer a).

### v) Monomer Comprising at Least Two Ethylenic Unsaturations

According to an embodiment, the copolymer a) may optionally comprise, as polymerized monomer, a monomer v) comprising at least two ethylenic unsaturations. If present, this monomer v) may be present in the copolymer a) at about 0-2 wt. %, based on dry weight of the copolymer a). According to some embodiments, the monomer v) comprises at least one of allylic ethers obtained from polyols; acrylic or methacrylic esters obtained from polyols; divinyl naphthalene; trivinylbenzene; 1,2,4-trivinylcyclohexane; triallyl pentaerythritol, diallyl pentaerythritol; diallyl sucrose; trimethylolpropane diallyl ether; 1,6-hexanediol di(meth)acrylate; allyl (meth)acrylate; diallyl itaconate; diallyl fumarate; diallyl maleate; butanediol dimethacrylate; ethylene di(meth) acrylate; poly(ethylene glycol) di(meth) acrylate; trimethylolpropane tri(meth)acrylate; methylenebis(meth)acrylamide; triallylcyanurates; diallyl phthalate; divinylbenzene; or mixtures thereof. If present, preferably this monomer v) is 1,6-hexanediol di(meth) acrylate; allyl (meth)acrylate; diallyl itaconate; ethylene di(meth) acrylate; poly(ethylene glycol) di(meth) acrylate; diallyl phthalate; divinylbenzene; or mixtures thereof, and more preferably is 1,6-hexanediol di(meth) acrylate; allyl (meth)acrylate; ethylene di(meth)acrylate; diallyl phthalate; divinylbenzene; or mixtures thereof.

According to some embodiments, the copolymer a) may comprise at least 0.05, 0.1, 0.2, 0.3, 0.4, 0.5, 0.6, 0.7, 0.8, 0.9, 1.0, 1.1, 1.2, 1.3, 1.4, 1.5, 1.6, 1.7, or at least 1.8 wt. % of the monomer v), as a polymerized monomer, based on the total dry weight of the copolymer a). According to some embodiments, the copolymer a) may comprise at most 2.0, 1.9, 1.8, 1.7, 1.6, 1.5, 1.4, 1.3, 1.2, 1.1, 1.0, 0.9, 0.8, 0.7, 0.6, 0.5, 0.4, 0.3, 0.2, 0.1 wt. % of the monomer v), as a polymerized monomer, based on the total dry weight of the copolymer a).

### b) Anionic Surfactant

The aqueous emulsion composition comprises about 0.5-5 wt % by dry weight of the copolymer a) of at least one anionic surfactant b) comprising at least one sulfonate group or acid or salt forms thereof. The anionic surfactant b) is not polymerizable with the copolymer a).

“Polymerizable” as used herein means a compound or composition having at least one unsaturated carbon-carbon bond which is subject to free radical polymerization. “Non-polymerizable” as used herein means a compound or composition lacking said unsaturated carbon-carbon bonds.

The anionic surfactant b) comprises at least one of alkyl sulfonates, alkylbenzene sulfonates, alkyldiphenyloxide disulfonates; or acid or salt forms thereof; or mixtures thereof. Non-limiting examples include linear alkyl benzene sulfonic acid, sodium lignosulfonate, sodium alkyl sulfonate, calcium lignosulfonate, sodium alkyl benzene sulfonate, disodium methylenebisnaphthalenesulfonate, sodium C14-16 alkyl sulfonates; or acid or salt forms; or mixtures thereof. Preferably the anionic surfactant is an alkyldiphenyloxide disulfonate; or acid or salt forms thereof. Dowfax™ 2A1 (The Dow Chemical Company) is a commercially available such surfactant.

The anionic surfactant b) is present in the aqueous emulsion composition in an amount of about 0.5-5 wt % by dry weight of the copolymer a). According to some embodiments, the aqueous emulsion composition may include at least 0.5, 0.6, 0.7, 0.8, 0.9, 1.0, 1.1, 1.2, 1.3, 1.4, 1.5, 1.6, 1.7. 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7 or 4.8 wt. % of the anionic surfactant b) by dry weight of the copolymer a). According to some embodiments, the aqueous emulsion composition may include at most 5.0, 4.9, 4.8, 4.7, 4.6, 4.5, 4.4, 4.3, 4.2, 4.1, 4.0, 3.9, 3.8, 3.7, 3.6, 3.5, 3.4, 3.3, 3.2, 3.1, 3.0, 2.9, 3.8, 3.7, 3.6, 3.5, 3.4, 3.3, 3.2, 3.1, 3.0, 2.9, 2.8, 2.7, 2.6, 2.5, 2.4, 2.3, 2.2, 2.1, 2.0, 1.9, 1.8, 1.7, 1.6, 1.5, 1.4, 1.3, 1.2, 1.1, or at most 1.0 wt. % of the anionic surfactant b) by dry weight of the copolymer a).

### Swelling

The aqueous emulsion composition as disclosed herein resists swelling when placed in contact with a non-aqueous solvent used in secondary batteries. According to an embodiment, a film of the aqueous emulsion composition having thickness 1±0.3 mm has a degree of swelling of less than 120% after exposure for three days at 60° C. to a mixed battery solvent consisting of a 1:1:1 weight ratio of ethylene carbonate, diethyl carbonate, and dimethyl carbonate. The degree of swelling is expressed as W₁/W₀×100, where W₀ is a weight of the film before the exposure to the solvent and W₁ is a weight of the film after the exposure to the solvent. According to some embodiments, the degree of swelling may be less than 119%, 118%, 117%, 116%, 115%, 114%, 113%, 112%, 111%, or less than 110% after exposure for three days at 60° C. to a mixed battery solvent consisting of a 1:1:1 weight ratio of ethylene carbonate, diethyl carbonate, and dimethyl carbonate.

Slurry Formed from the Aqueous Emulsion Composition

A slurry composition for forming an electrode for a non-aqueous secondary battery is provided. The slurry composition comprises the aqueous emulsion composition described above and at least one particulate electrode-forming material.

The particulate electrode forming material includes particulate active materials and conductive particles that are held together (physically and/or chemically) by the aqueous emulsion composition. The active materials are materials that are capable of intercalating lithium ions, i.e., are able to absorb/release lithium ions. Such active materials are known in the art. Conductive particles are also known in the art and are materials capable of conducting electrons. Certain materials are capable of performing both functions in an electrode.

The particulate electrode-forming materials may include but are not limited to a conductive carbon additive, carbon nanotubes (CNTs), synthetic graphite, natural graphite, hard carbon, activated carbon, carbon black, graphene, mesoporous carbon, amorphous silicon, semi-crystalline silicon, silicon oxides, silicon nanowires, tin, tin oxides, germanium, lithium titanate, mixtures or composites of the aforementioned materials, and/or other materials known in the art or described herein as suitable for use as an electrode in a lithium ion battery. These particulates may include active materials, i.e., materials capable of intercalating (accepting) lithium ions, and conductive materials. The electrode film of a lithium ion capacitor and/or a lithium ion battery can include about 80 weight percent, preferably up to 94, and more preferably up to 98 weight percent of the particulate electrode-forming materials, after drying. These electrode-forming materials a) are typically in the form of solid powders.

Conductive carbon materials such as carbon black and graphite powders are widely used in positive and negative electrodes to decrease the inner electrical resistance of an electrochemical system. Non-limiting examples of conductive carbon may include furnace black, acetylene black, CNT, fine graphite powder, vapor deposited graphite fibers, and Ketjen carbon black. The typical loading level of the conductive carbon relative to the active material in the electrode forming materials is usually within the range of 0.1% by weight to 20% by weight, and more preferably within the range of 0.5% by weight to 10% by weight of the total amount of the particulate electrode-forming materials.

The amount of the particulate electrode-forming materials (including both the active material and the conductive carbon) present in the electrode forming slurry composition, may be from 50 wt % to 99 wt % of the total dried weight of the slurry composition, preferably from 80 to 98 and most preferably from 94 to 98 wt % of the total dried weight of the composition.

According to an embodiment, the at least one particulate electrode-forming material comprises at least one of furnace black, acetylene black, Ketjen carbon black, carbon nanotubes (CNTs), synthetic graphite, natural graphite, hard carbon, activated soft carbon, carbon black, graphene, mesoporous carbon, amorphous silicon, semi-crystalline silicon, silicon oxides, silicon nanowires, tin, tin oxides, germanium, lithium titanate; or mixtures or composites thereof.

### Other Additives

Other additives may optionally be included in the slurry composition as are known and used in the art. Importantly, these optional additives are in addition to the anionic surfactant b) discussed above. These optional additives include wetting agents, antisettling agent dispersing agents, adhesion promoters, coalescent agents, rheology modifier additives, anti-settling agents, surfactants, and mixtures thereof.

Surfactants and/or anti-settling agents may be added to the aqueous composition at 0 to 10 parts, preferably from 0.1 to 10 parts, and more preferably 0.5 to 5 parts per 100 parts of water. These anti-settling agents or surfactants are added to the aqueous composition post-polymerization, generally to improve the shelf stability, and provide additional stabilization during slurry preparation. Some surfactant/anti-settling agent may also be present in the aqueous composition remaining from the polymerization process. Useful anti-settling agents include, but are not limited to, ionic surfactants such as salts of alkyl sulfates, (such as sodium lauryl sulfate and ammonium lauryl sulfate), carboxylates, phosphates, phosphonates (such as those sold under the CAPSTONE brand name by DuPont), and non-ionic surfactants such as the TRITON X series (from Dow) and PLURONIC series (from BASF). In one embodiment, only anionic surfactants are used. It is preferred that no fluorinated surfactants are present in the aqueous composition, either residual surfactant from the polymerization process, or added post-polymerization in forming or concentrating an aqueous dispersion.

Wetting agents may be incorporated into the aqueous composition at from 0 to 5 parts, and preferably from 0 to 3 parts per 100 parts of water. Surfactants can serve as wetting agents, but wetting agents may also include non-surfactants. In some embodiments, the wetting agent can be an organic solvent. Useful wetting agents include, but are not limited to, ionic and non-ionic surfactants such as the TRITON™ series (from Dow) and the PLURONIC® series (from BASF), and organic liquids that are compatible with the aqueous composition, including but not limited to N-methyl-2-pyrrolidone (NMP), dimethyl sulfoxide (DMSO), or acetone.

Thickeners and rheology modifiers may be present in the aqueous composition at from 0 to 10 parts, preferably from 0 to 5 parts per 100 parts of water. The addition of water-soluble thickener or rheology modifier to the aqueous composition prevents or slows down the settling of inorganic powdery materials while providing appropriate slurry viscosity for a coating process. Useful thickeners include, but are not limited to the ACRYSOL™ series (from Dow Chemical); RHEOTECH™ series (from Coatex), VISCOATEX™ series (from Coatex) partially neutralized poly (acrylic acid) or poly(methacrylic acid) such as Carbopol® from Lubrizol or VISCODIS® 100N from Coatex; and carboxylated alkyl cellulose, such as carboxylated methyl cellulose (CMC). Adjustment of the pH of the aqueous composition can improve the effectiveness of some of the thickeners. In addition to organic rheology modifiers, inorganic rheology modifiers can also be used alone or in combination. Useful inorganic rheology modifiers include, but are not limited to, inorganic rheology modifiers including but not limited to natural clays such as montmorillonite and bentonite, manmade clays such as laponite, and others such as silica, and talc.

An optional fugitive adhesion promoter helps to produce the interconnectivity needed in coatings formed from the composition of the invention. By “fugitive adhesion promoter” as used herein is meant an agent that increases the interconnectivity of the composition after coating. The fugitive adhesion promoter is then capable of being removed from the formed substrate generally by evaporation (for a chemical) or by dissipation (for added energy).

The fugitive adhesion promoter can be a chemical material, an energy source combined with pressure, or a combination, used at an effective amount to cause interconnectivity of the components of the aqueous composition during formation of the electrode. For chemical fugitive adhesion promoters, the composition contains 0 to 150 parts, preferably 0 to 100 parts, and more preferably from 0 to 30 parts, of one or more fugitive adhesion promoters per 100 parts of water. Preferably this is an organic liquid, that is soluble or miscible in water. This organic liquid acts as a plasticizer or coalescent agent acrylic particles, making them tacky and capable of acting as discrete adhesion points during the drying step. The binder particles are able to soften, flow and adhere to powdery materials during drying stage, resulting in electrodes with high connectivity that are non-reversible. In one embodiment useful organic solvent or coalescent agents include, but are not limited to Texanol™ (Eastman), Optifilm™ 400 (Eastman), Velate™ 368 (Eastman), Butyl Carbitol™ (Dow), Dowanol™ DPM (Dow), Citroflex® 4 (Vertellus Specialties), Benzoflex™ 50 (Eastman) Loxanol® CA5310 (BASF).

### Applications

The slurry composition may be used as the active layer or coating on an electrode such as an anode for use within an electrical energy storage device. Also disclosed is an electrode such as an anode made from a current collector coated on at least one surface with the electrode forming slurry composition disclosed herein in dried form, such that the electrode such as an anode has a thickness of at least 10 microns.

The electrode such as an anode may be used in an electrical energy storage device containing a non-aqueous electrolyte. The electrical energy storage device comprising at least one electrode such as an anode is made from a current collector coated on at least one surface with the electrode forming slurry composition disclosed herein in dried form. The electrical energy storage device is selected from the group consisting of a non-aqueous-type battery, a capacitor, and a membrane electrode assembly.

An electrode assembly for a non-aqueous secondary battery comprising an electroconductive substrate coated on at least one surface with the slurry composition is provided. Advantageously, the electrode assembly is an anode or a cathode, and preferably is an anode.

### EXAMPLES

### Evaluation Methods:

### Binder Swelling Resistance to Battery Solvent

Polymeric binder in latex form was first dried at a temperature between 23° C. and 25° C. to form a film with a thickness of 1±0.3 mm. The resultant film was further dried for 2 hours in an oven at 110° C. Approximately 0.6 g of the dried film was cut out and weighed. The film piece with an initial weight of W₀ was immersed in a mixed battery solvent (1:1:1 by weight of ethylene carbonate/diethyl carbonate/dimethyl carbonate) for 3 days at 60° C., and was allowed to swell. Thereafter, the film piece was pulled out of the solvent and the mass thereof was measured after solvent on the surface of the film piece had been wiped off using a Kimwipe. The mass of the swollen film piece was taken to be W₁. The degree of swelling in the battery solvent was calculated using the following calculation formula: swell %=W₁/W₀×100. A swell % less than 120% is desired for battery applications.

### Example 1: Production of Binder

Into a 1 gallon reactor was introduced an initial charge composed of 534 g of deionized water and 0.9 g of Rhodacal® A-246 MBA (sodium alpha olefin sulfonate surfactant). Then, 16.2 g of Sipomer PAM 4000 (ethylmethacrylate phosphate), 400.4 g of 2-ethylhexyl acrylate, 436.1 g of styrene, 36.1 g of methyl methacrylate, 18.0 g of sodium 4-vinylbenzenesulfonate were weighed out into a first glass beaker and mixed with 5.9 g of Rhodacal® A-246 MBA and 365 g of deionized water to prepare a monomer pre-emulsion. Then 2.2 g of ammonium persulfate was weighed in a second glass beaker, dissolved in 15 g of deionized water to prepare the initial initiator. Next 1.0 g of ammonium persulfate was dissolved in 32.0 g water in a third beaker to prepare the delayed initiator. The contents of the reactor were heated to a temperature of 83±2° C. After that, 63.9 g of the monomer pre-emulsion and the initial initiator were first introduced into the reactor. After the peak of the reaction exotherm, the remaining monomer pre-emulsion and the delayed initiator were fed into the reactor while keeping the reactor temperature at 90±2° C. The delayed initiator solution was fed into the reactor over 260 minutes. The monomer pre-emulsion was fed into the reactor over 4 stages. Then 303.5 g of the monomer pre-emulsion was fed into the reactor over 45 minutes, followed by a 15 minutes feed pause. Then the rest of the monomer pre-emulsion was fed into the reactor following the same feeding profile over three stages. After the completion of the delayed initiator feed over 260 minutes, the contents of reactor was cooked for 30 minutes before allowing the mixture to cool to 70° C. During the 30 minute cook, a post oxidizer solution containing 2.6 g of 70% t-butyl hydroperoxide and 23.3 g of deionized water was prepared in a glass beaker. A post reducer solution containing 1.8 g of Bruggolite® FF6M (reducing agent) and 45 g of deionized water was also prepared in a glass beaker. The post oxidizer and post reducer solutions were then fed into the reactor over 75 minutes after the 30 minute cook period. The mixture was allowed to cool, and then was filtered. Then 500 g of the filtered latex was weighed into a separate beaker. To the beaker, 5.1 g of Dowfax™ 2A1 (anionic surfactant b)) was added into the 500 g filtered latex in one shot under agitation. The mixed blend is Example 1.

### Comparative Example 1: Production of Binder

The latex in Example 1 without post-added Dowfax™ 2Al (anionic surfactant b)) was used as Comparative Example 1.

### Example 2

Into a 1 gallon reactor was introduced an initial charge composed of 490 g of deionized water and 0.9 g of Rhodacal® A-246 MBA. Then 16.2 g of Sipomer PAM 4000, 384.0 g of 2-ethylhexyl acrylate, 436.1 g of styrene, 36.1 g of methyl methacrylate, 18.0 g of sodium 4-vinylbenzenesulfonate, 16.4 g of methacrylic acid were weighed out in a first glass beaker and mixed with 5.9 g of Rhodacal® A-246 MBA, 21.1 g of Disponil® FES32 (fatty alcohol polyglycol ether sulphate, Na-salt) and 348 g of deionized water to prepare monomer pre-emulsion. Then 2.2 g of ammonium persulfate was weighed in a second glass beaker, dissolved in 15 g of deionized water to prepare the initial initiator. Then 1.0 g of ammonium persulfate was dissolved in 32.0 g water in a third beaker to prepare the delayed initiator. The contents of the reactor were heated to a temperature of 83±2° C. Then 64.1 g of the monomer pre-emulsion and the initial initiator were first introduced into the reactor. After the peak of the reaction exotherm, the remainder of the monomer pre-emulsion and the delayed initiator were fed into the reactor while keeping the reactor temperature 90±2° C. The delayed initiator solution was fed into the reactor over 260 minutes. The monomer pre-emulsion was fed into the reactor over 4 stages. Then 304.5 g of the monomer pre-emulsion was fed into the reactor over 45 minutes, followed by a 15 minute feed pause. Then the rest of the monomer pre-emulsion was fed into the reactor following the same feeding profile over three stages. After the completion of the delayed initiator feed over 260 minutes, the contents of the reactor was cooked for 30 minutes before allowing the mixture to cool to 70° C. During the 30 minute cook, a post oxidizer solution containing 2.6 g of 70% t-butyl hydroperoxide and 23.3 g of deionized water was prepared in a glass beaker. A post reducer solution containing 1.8 g of Bruggolite® FF6M and 45 g of deionized water was also prepared in a glass beaker. After the 30 minute cook, 13.0 g of 14% weight ammonia was added to the reactor in one shot. Then the post oxidizer and post reducer solutions were fed into the reactor over 45 minutes. The mixture was allowed to cool, and filtered. 500 g of the filtered latex was weighed into a separate beaker. Then 5.2 g of Dowfax™ 2A1 was added into the 500 g filtered latex in one shot under agitation. The mixed blend is Example 2.

### Comparative Example 2

The latex in Example 2 without post-added Dowfax™ 2Al was used as Comparative Example 2.

### Example 3

Into a 1 gallon reactor was introduced an initial charge composed of 450 g of deionized water and 0.9 g of Rhodacal® A-246 MBA. Then 16.2 g of Sipomer PAM 4000, 384.0 g of 2-ethylhexyl acrylate, 436.1 g of styrene, 36.1 g of methyl methacrylate, 18.0 g of sodium 4-vinylbenzenesulfonate, 16.4 g of methacrylic acid were weighed out in a first glass beaker and mixed with 5.9 g of Rhodacal® A-246 MBA, 14.0 g of Dowfax™ 2A1 and 348 g of deionized water to prepare the monomer pre-emulsion. Then 2.2 g of ammonium persulfate was weighed in a second glass beaker, dissolved in 15 g of deionized water to prepare the initial initiator. Then 1.0 g of ammonium persulfate was dissolved in 32.0 g water in a third beaker to prepare the delayed initiator. The contents of the reactor was heated to a temperature of 83±2° C. Then 63.8 g of the monomer pre-emulsion and the initial initiator were first introduced into the reactor. After the peak of the reaction exotherm, the remainder of the monomer pre-emulsion and the delayed initiator were fed into the reactor while keeping the reactor temperature 90±2° C. The delayed initiator solution was fed into the reactor over 260 minutes. The monomer pre-emulsion was fed into the reactor over 4 stages. Then 302.8 g of the monomer pre-emulsion was fed into the reactor over 45 minutes, followed by a 15 minutes feed pause. Then the rest of the monomer pre-emulsion was fed into the reactor following the same feeding profile over three stages. After the completion of the delayed initiator feed over 260 minutes, the contents in reactor was cooked for 30 minutes before allowing the medium to cool to 70° C. During the 30 minute cook, a post oxidizer solution containing 2.6 g of 70% t-butyl hydroperoxide and 23.3 g of deionized water was prepared in a glass beaker. A post reducer solution containing 1.8 g of Bruggolite® FF6M and 45 g of deionized water was also prepared in a glass beaker. After the 30 minute cook, 15.0 g of 14% weight percent ammonia was added to the reactor in one shot. Then the post oxidizer and post reducer solutions were fed into the reactor over 45 minutes. The mixture was allowed to cool, and filtered.

### Comparative Example 3

The sample was prepared in the same manner as Example 1, except that monomer selection and ratio were different. The weight percentage of each monomer to total monomer used is listed in Table 1. In addition, Comparative Example 3 also does not contain Dowfax™ 2A1 (anionic surfactant b)) as post addition.

### Comparative Example 4

The sample was prepared in the same manner as Example 1, except that monomer selection and ratio were different. The weight percentage of each monomer to total monomer used is listed in Table 1. In addition, Comparative Example 4 also does not contain Dowfax™ 2A1 (anionic surfactant b)) as post addition.

TABLE 1
Polymer binder compositions by monomer
weight percentage and binder swell %

| | | Comp. | | Comp. | | Comp. | Comp. |
|---|---|---|---|---|---|---|---|
| | Ex. 1 | Ex. 1 | Ex. 2 | Ex. 2 | Ex. 3 | Ex. 3 | Ex. 4 |
| | wt. % | wt. % | wt. % | wt. % | wt. % | wt. % | wt. % |
| Sty | 48.2 | 48.2 | 48.2 | 48.2 | 48.2 | 50 | 49.9 |
| 2EHA | 44.2 | 44.2 | 42.4 | 42.4 | 42.4 | 44.2 | 44.2 |
| MMA | 4 | 4 | 4 | 4 | 4 | 4 | 4 |
| PAM | 1.8 | 1.8 | 1.8 | 1.8 | 1.8 | 1.8 | 1.8 |
| NaSS | 1.8 | 1.8 | 1.8 | 1.8 | 1.8 | | |
| MAA | | | 1.8 | 1.8 | 1.8 | | |
| DVB | | | | | | | 0.1 |
| A246 | 0.3 | 0.3 | 0.3 | 0.3 | 0.3 | 0.3 | 0.3 |
| FES 32 | | | 0.7 | 0.7 | | | |
| 2A1 | 1 | | 1 | | 0.7 | | |
| Swell % | 112 | 130 | 113 | 123 | 109 | 160 | 130 |

Comparing Example 1 and Comparative Example 1 in Table 1, the sulfonate surfactant contain Dowfax™ 2A1 (anionic surfactant b)) significantly improves the polymer's swelling percentage from 130% (Comparative Example 1) to 112% (Example 1), since lower swelling percentages are more desirable. Similarly, the sulfonate containing anionic surfactant b) also provides the same effect as can be seen by comparing Example 2 (113%) to Comparative Example 2 (123%). In Comparative Example 3 and Comparative Example 4, the two polymers that do not contain the required sulfonate monomer and separately added surfactant have large swelling percentages in the battery solvent mixture. The large swelling percentages are not desired for binders for lithium ion battery applications. In Example 3 the polymer including the required sulfonate monomer, the separately added sulfonate surfactant and the optional methacrylic acid had the best (lowest) swelling percentage.

### Abbreviations in Table 1

Sty=styrene
2EHA=2-ethylhexyl acrylate
MMA=methyl methacrylate
PAM=phosphoethyl methacrylate (ethylmethacrylate phosphate)
NaSS=sodium 4-styrenesulfonate
MAA=methacrylic acid
DVB=divinylbenzene
A246=Rhodacal® A 246MBA, sodium salt of alpha olefin sulfonate, surfactant
FES32=Disponil® FES 32, sodium salt of fatty alcohol ether sulfate, surfactant
2A1=DOWFAX™ 2A1, alkyldiphenyloxide disulfonate surfactant, surfactant

### Example 1: Preparation of Slurry

Seven 6.5 mm zirconia balls are placed into a 125 mL container of a Thinky ARE-310. Then, 0.3 g of carbon black (Super P-Li from Timcal) plus 4.5 g of carboxymethylcellulose (CMC) solution (Ashland Bondwell BVH9) at 1.5% solids and 13 g of graphite (15 μm) are added and mixed at 2000 rpm for 2 minutes. Then, 3.5 g of CMC solution is added and mixed at 2000 rpm for 2 minutes, followed by several incremental CMC solution additions and mixing to reach 11.2 g total CMC solution addition. Then, 2.8 g of the Example 1 emulsion from Table 1 is added and mixed for 2 minutes at 2000 rpm, twice. The slurry exhibits a smooth creamy characteristic and has about 50 wt % solids.

### Example 2: Preparation of Electrode

The slurry prepared in Example 1 is cast onto copper foil with a wet thickness of about 110 μm, using a 5-mil Square Frame applicator from BYK. The cast electrode is placed in a convection oven for 30 minutes at 120° C. and then calendared at room temperature to reach porosity of about 20% by volume. Porosity of the electrodes is back calculated from its expected (weight contribution of each component) and apparent density where the apparent density is obtained by measuring weight and volume of the electrode using a micrometer and 5 decimal point balance.

1. An aqueous emulsion composition for a non-aqueous battery electrode, the composition comprising:
a) a copolymer comprising, as polymerized monomers, based on a dry weight of the copolymer:
i) about 0.1-10 wt % of at least one ethylenically unsaturated ionic monomer comprising at least one functional group selected from phosphate, phosphonate; or acid or salt forms thereof;
ii) about 0.1-10 wt % of at least one ethylenically unsaturated ionic monomer comprising at least one sulfonate group or acid or salt forms thereof;
iii) about 80-99.8 wt % of at least one non-ionic monoethylenically unsaturated monomer;
iv) optionally about 0-10 wt % of at least one ethylenically unsaturated ionic monomer comprising at least one functional group selected from carboxylate, or acid or salt or anhydride forms thereof; and
v) optionally about 0-2 wt % of at least one monomer comprising at least two ethylenic unsaturations; and
b) about 0.5-5 wt % based on the dry weight of the copolymer a) of at least one anionic surfactant comprising at least one sulfonate group, or acid or salt forms thereof, wherein the anionic surfactant is not polymerizable with the copolymer a).

2. The aqueous emulsion composition of claim 1, wherein the anionic surfactant b) comprises at least one of alkyl sulfonates, alkylbenzene sulfonates, alkyldiphenyloxide disulfonates; or acid or salt forms thereof; or mixtures thereof.

3. The aqueous emulsion composition of claim 1, wherein the monomer i) comprises at least one of phosphate esters of polyalkylene glycol mono(meth)acrylate, polyalkylene glycol allyl ether phosphates, vinylphosphonic acid, 2-(methacryloyloxy)ethyl phosphonic acid; or acid or salt or anhydride forms thereof; or mixtures thereof.

4. The aqueous emulsion composition of claim 1, wherein the monomer ii) comprises at least one of 2-acrylamide-2-methylpropane sulfonic acid, 4-styrenesulfonic acid, vinylsulfonic acid, 2-sulfoethyl methacrylate, sulfoethyl acrylate, sulfopropyl methacrylate, sulfopropyl acrylate; or salt forms thereof; or mixtures thereof.

5. The aqueous emulsion composition of claim 1, wherein the monomers i) and ii) comprise a single ionic monomer and the single ionic monomer comprises both the at least one functional group selected from phosphate, phosphonate; or acid or salt forms thereof; and the at least one sulfonate group or acid or salt forms thereof; and wherein the copolymer a) comprises from 0.2-20 wt % of the single ionic monomer.

6. The aqueous emulsion composition of claim 1, wherein the monomer iii) comprises at least one of C1 to C12 alkyl (meth)acrylate, styrene or derivatives thereof, vinyl acetate, vinyl versatate, (meth)acrylamide, (meth)acrylonitrile or derivatives thereof, diisobutylene, vinylpyrrolidone, vinylcaprolactam; or mixtures thereof.

7. The aqueous emulsion composition of claim 1, wherein the monomer iv) comprises at least one of (meth)acrylic acid, 2-carboxyethyl acrylate, 2-polycarboxy ethyl acrylate, mono-ester of itaconic acid, maleic acid, fumaric acid, crotonic acid, itaconic acid; or acid or salt or anhydride forms thereof; or mixtures thereof.

8. The aqueous emulsion composition of claim 1, wherein the monomer v) comprises at least one of allylic ethers obtained from polyols; acrylic or methacrylic esters obtained from polyols; divinyl naphthalene; trivinylbenzene; 1,2,4-trivinylcyclohexane; triallyl pentaerythritol; diallyl pentaerythritol; diallyl sucrose; trimethylolpropane diallyl ether; 1,6-hexanediol di(meth) acrylate; allyl (meth)acrylate; diallyl itaconate; diallyl fumarate; diallyl maleate; butanediol dimethacrylate; ethylene di(meth) acrylate; poly(ethylene glycol) di(meth) acrylate; trimethylolpropane tri(meth)acrylate; methylenebis(meth)acrylamide; triallylcyanurates; diallyl phthalate; divinylbenzene; or mixtures thereof.

9. The aqueous emulsion composition of claim 1, wherein the copolymer a) has a Tg of less than 55° C., wherein the Tg is determined using the Fox equation.

10. The aqueous emulsion composition of claim 1, wherein the copolymer a) has a minimum film forming temperature of less than 25° C.

11. The aqueous emulsion composition of claim 1, wherein the copolymer a) comprises particles having a volume average particle size of from 30 to 500 nm.

12. The aqueous emulsion composition of claim 1, wherein the copolymer a) has a number average molecular weight of at least 1000 g/mol.

13. The aqueous emulsion composition of claim 1, wherein a film of the aqueous emulsion composition having a thickness of 1±0.3 mm has a degree of swelling of less than 120% after exposure for three days at 60° C. to a mixed battery solvent consisting of a 1:1:1 weight ratio of ethylene carbonate, diethyl carbonate, and dimethyl carbonate; wherein the degree of swelling is expressed as W₁/W₀×100, where W₀ is a weight of the film before the exposure and W₁ is a weight of the film after the exposure.

14. A slurry composition for forming an electrode for a non-aqueous secondary battery, the composition comprising:
at least one particulate electrode-forming material; and
the aqueous emulsion composition of claim 1.

15. The slurry composition of claim 14, wherein the at least one particulate electrode-forming material comprises at least one of furnace black, acetylene black, Ketjen carbon black, carbon nanotubes (CNTs), synthetic graphite, natural graphite, hard carbon, activated soft carbon, carbon black, graphene, mesoporous carbon, amorphous silicon, semi-crystalline silicon, silicon oxides, silicon nanowires, tin, tin oxides, germanium, lithium titanate; or mixtures or composites thereof.

16. An electrode assembly for a non-aqueous secondary battery comprising an electroconductive substrate coated on at least one surface with the slurry composition of claim 14.
